(19) United States
(12) Patent Application Publication
(10) Pub. No.: US 2016/0281395 A1
(43) Pub. Date: Sep. 29, 2016

(54) MOTOR VEHICLE DOOR

(71) Applicant: KIEKERT AG, Heiligenhaus (DE)

(72) Inventors: Michael Scholz, Essen, North Rhine-Westphalia (DE); Holger Schiffer, Meerbusch, North Rhine-Westphalia (DE)

(21) Appl. No.: 14/907,948

(22) PCT Filed: Jul. 10, 2014
(86) PCT No.: PCT/DE2014/100241

§ 371 Date: Mar. 18, 2016

(30) Foreign Application Priority Data
Jul. 31, 2013 (DE) 10 2013 108 227.0

(51) Int. Cl. E05B 77/38; E05B 79/10; E05B 77/04; E05B 85/24

(52) U.S. Cl. CPC E05B 77/38; E05B 85/24; E05B 79/10; E05B 77/04

(57) ABSTRACT

The invention relates to a motor vehicle door equipped with a motor vehicle door lock and an associated closing bolt. The invention also relates to a stop device with a corresponding damping element. Said stop device interacts at least with the relevant locking bolts for the damping movement thereof, in locking bolts introduced into the motor vehicle door lock. According to the invention, the stop device is designed as a damping module arranged between the motor vehicle door lock and a door skin.

### BACKGROUND

The invention relates to a motor vehicle door, with a motor vehicle door latch and a pertaining locking bolt, and with a stop device with corresponding attenuator, whereby the stop device interacts at least on the locking bolt entering the motor vehicle door latch with the relevant locking bolt for the attenuation of its movement.

As usual, the motor vehicle door latch possesses a locking mechanism fundamentally comprising a catch and a pawl in its interior. The locking bolt interacts with the catch to close or lock the motor vehicle door with a chassis. For example, the motor vehicle door latch can be arranged inside the motor vehicle door and interact with the locking bolt incorporated into the chassis. The procedure is usually followed for motor vehicle side doors.

However, it is also possible for the chassis to demonstrate the connected motor vehicle door latch, whereas the motor vehicle door is equipped with the locking bolt. For example, there are tailgates which function in this way. In both cases, both the locking mechanism and the locking bolt are robustly and regularly made of steel to optimally protect occupants inside the chassis especially in the event of an accident and to prevent the motor vehicle door in question from unintentionally springing open.

The robust and especially metallic design of the locking bolt on the one hand and the locking mechanism or its catch on the other hand leads to ‘metallic’ noises occurring during the manual closure process of the motor vehicle door which are considerable and sometimes irritating. This applies even if the actual closed position of the motor vehicle door is brought about by a closing aid. Because in this case too the motor vehicle door initially needs to be manually transferred to a pre-latching position which corresponds to an interaction of the catch and the locking bolt.

In the acknowledged state of the art in accordance with DE 10 2005 016 186 A1 a stop device with a pivoting section is proposed for this purpose. Against the pivoting section, the locking bolt or another stop part becomes adjacent when the motor vehicle door is closed. When the motor vehicle door is closed again, an attenuator and/or a spring element on the pivoting part causes a force or a torque. With the aid of this force or the torque, an energetic closure of the motor vehicle door is attenuated or decelerated. This has been proven in principle. However, the known motor vehicle door latch with the pertaining stop device is of a complicated construction and requires more or less far-reaching interventions to the latch construction. This is disadvantageous with regard to current requirements for a cost-effective and versatile construction.

In the case of an unlockable snap lock in accordance with DE 1 801 154 A a spring is provided for which engages with the catch. The movement of the catch is thus attenuated.

DE 35 07 405 C1 which is ultimately to be stated in this context relates to a closure device for a motor vehicle door which is equipped with a knee lever arrangement. The knee lever arrangement engages with the catch and the housing. With the aid of an activation device, a torque can be initiated into the catch via the knee lever with which the motor vehicle door can be transferred into its closed position against the force of an elastically deformed door seal. The knee lever is spring-loaded by means of a pivotable pulling handle. In this case too a complex construction is observed which needs to be adapted in particular to the motor vehicle latch which is to be equipped accordingly.

### SUMMARY

The invention is based on the technical problem of further developing such a motor vehicle door in such a way that a simplified construction is observed and there is also the possibility of working with standardized construction elements.

In order to solve this technical issue, a motor vehicle door in accordance with the genre within the scope of the invention is characterized in that the stop device is formed as an attenuation module arranged between the motor vehicle latch and a door panel. The previously referred to door panel may not restrictedly be a connecting panel which connects an internal door panel and external door panel of the motor vehicle door in accordance with the invention, for example in the front area of a side door. The same applies to a tailgate. In any case, the attenuation module provided for in accordance with the invention is interposed between the motor vehicle door latch in question and the relevant door panel.

In the state of the art the motor vehicle door latch is directly connected to the stated door panel or connecting panel, for example a latch case of the motor vehicle door latch is screwed together with the relevant door panel. In accordance with the invention, the attenuation module is now interposed here. According to general language usage, the term attenuation module describes a constructional unit which together with the motor vehicle door latch is connected as a further constructional unit in terms of a constructional case and can be attached as a whole to the motor vehicle door or the relevant door panel. All attachment methods are included by the invention in this context. Generally, the attenuation module in accordance with the invention is screwed between the door panel of the motor vehicle door and the motor vehicle door latch.

This means that the motor vehicle door latch or there in general the latch case is for example equipped with a thread hole in which a screw passing through the door panel and the attenuation module engages. Usually several screws and threads are distributed over the latch case. In any case, the motor vehicle door latch and the attenuation module are modularly connected in terms of a modular or constructional principle as described and can be connected to the door panel.

In general, the attenuation module has at least one deflection lever interacting with the locking bolt. This deflection lever is generally arranged in the area of an infeed section of the motor vehicle door latch. Thus, the deflection lever can interact directly and easily with the locking bolt plunging into the infeed section. Because the design is usually such that the locking bolt enters or plunges into the infeed section of the motor vehicle door latch when the motor vehicle door is closed and interacts with the catch located there. Thus, the locking bolt regularly transfers the catch into its pre-latching position or also its main latching position.

In this process, the locking bolt meets the deflection lever of the attenuation module in accordance with the invention. Thus, the deflection lever is deflected or pivoted and works on the attenuation element. Consequently, the movement of the locking bolt along the infeed section of the motor vehicle door latch is attenuated as requested.

The attenuation module is generally equipped with an adapter plate incorporating individual components. The purpose of the adapter plate in question in this context in general is not only to house the deflection lever, but also usually to incorporate an additional activation lever and sensors if necessary. Furthermore, the adapter plate is advantageously connected to the motor vehicle door latch by means of spacer sleeves. In this context, the spacer sleeves usually pass through several screws with the aid of which the motor vehicle door latch is fixed on the door panel with interposition of the attenuation module in accordance with the invention.

The components incorporated by the adapter plate are mainly all connected to the adapter plate on one side. This means that all of the stated components are found on one side of the two-sided adapter plate. The design is regularly effected in such a way that the components are located in an intermediate space defined by the spacer sleeves. This intermediate space is regularly deflected towards the motor vehicle door latch or the latch case there. Thus, the components of the attenuation module experience an especially protected arrangement and placement. Because the intermediate space in question is ultimately defined between the latch case of the motor vehicle door latch and the adapter plate.

As already explained, the attenuation module typically also possesses a transfer lever in addition to the deflection lever. Thus, both levers can be mechanically connected via shifting contours. However, according to an advantageous design, the deflection lever is pivotably located on the transfer lever. The transfer lever is usually pivotably connected to the adapter plate.

Furthermore, it has been proven when the attenuation module is equipped with at least one sensor already discussed, for example a microswitch. This sensor is regularly also placed in the intermediate space in question which is defined by the spacer sleeves and set between the motor vehicle door latch and the adapter plate. With the aid of the sensor or microswitch, the attenuation element or other latch functions can be controlled.

Thus, for example, it is conceivable to vary the attenuation or resistance of the attenuation element dependent on a position of the locking bolt. This can be queried via the sensor. If the locking bolt exceeds a certain position, which corresponds to the deflection lever experiencing its maximum deflection, the sensor then triggered can ensure that the attenuation of the attenuation element is reduced or completely switched off.

Alternatively or additionally it is also possible to control a closure device via at least one sensor. In this case, the attenuation module is equipped with the closure device in question, which is at least controlled via the catch located in the pre-latching position in order to pull the locking bolt so far into the infeed section of the motor vehicle door latch until the catch engages in its main latching position with mechanical assistance. This process can also be initiated by the sensor in question or its activation.

The attenuation element can be any suitable mechanical element which is suited to the attenuation of the continued movement of the locking bolt within the infeed section of the motor vehicle door latch. This includes springs, rubber springs, oil dampers, air dampers, etc. This also naturally includes combinations of the invention. The design usually happens in such a way that the transfer lever carries the housed deflection lever at its one end while the other end works on the relevant attenuation element.

This can happen in such a way that this attenuation end of the transfer lever is equipped with an installation contour which, for example, pressurizes a stamp plunging into the attenuation element

As soon as the deflection lever is pivoted by the locking bolt entering the infeed section of the motor vehicle door latch, this pivoting movement of the deflection lever is transferred to the transfer lever which, as a consequence thereof, pressurizes the stamp of the attenuation element with the installation contour at the attenuation end. In so doing, the installation contour in question may shift at a head-sided surface of the stamp during the corresponding pivoting movement of the attenuation end.

As a result, a motor vehicle door is provided which is equipped with an autonomous attenuation module. This attenuation module can be easily retrofitted or also converted. The possibility thus exists to equip any motor vehicle door latches with the attenuation module in question. Any modifications to the motor vehicle door latch in question are not explicitly necessary in this context.

Because the motor vehicle door latch on the one hand and the attenuation module on the other hand are combined in any manner in the way of a constructional case and fixed together to the door panel of the motor vehicle door. The motor vehicle door latch is also further stabilized as a result of the adapter plate achieved here. The design is usually effected in such a way that the latch case of the motor vehicle door latch, the adapter plate of the attenuation module in accordance with the invention and ultimately the two aforementioned constructional units or door panel incorporating the modules are arranged more or less in parallel to one another. Consequently, a solution which is especially stable from a mechanical viewpoint is provided. Furthermore, the adapter plate located between the door latch and the door panel ensures that the stop device as a whole is protected from mechanical damage. These are the crucial advantages.

Hereinafter, the invention is explained in further detail on the basis of a sketch which only depicts an execution example. It shows:

### BRIEF DESCRIPTION OF THE DRAWINGS

FIG. 1 the motor vehicle door latch in accordance with the invention together with the attenuation module in two different perspectives and

FIG. 2 the attenuation module in detail again in two different perspectives.

### DETAILED DESCRIPTION OF THE DRAWINGS

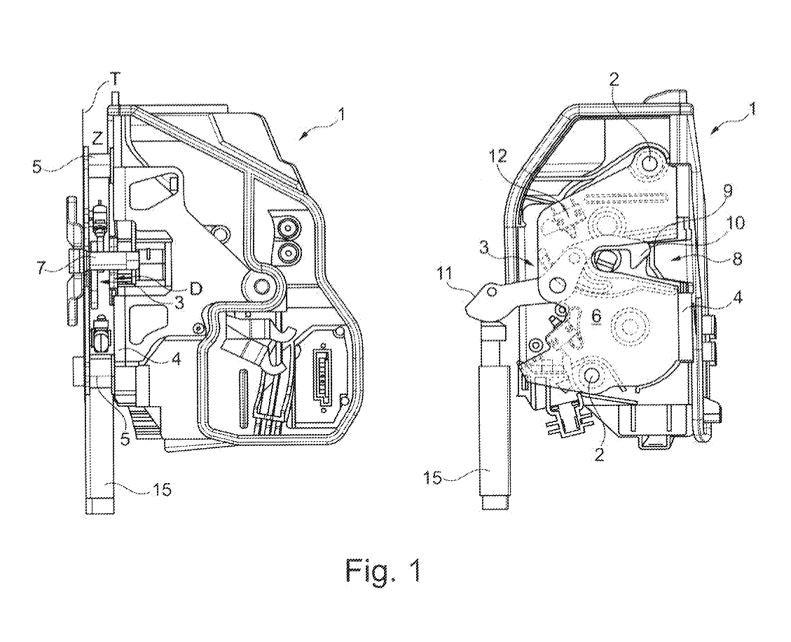

In FIG. 1 a motor vehicle door latch 1 is depicted which is connected to a motor vehicle door or a door panel T of the motor vehicle door with the aid of screws 2 in the example case and is only profiled in the left section of FIG. 1. In addition to the motor vehicle door latch 1 the motor vehicle door in question is still equipped with a stop device 3 with a pertaining attenuation element 15. The door panel T profiled in the left section of FIG. 1 to attach the motor vehicle door latch 2 is not restrictedly a front connecting panel between an external door panel and an internal door panel of the motor vehicle door executed in the present case as the motor vehicle side door.

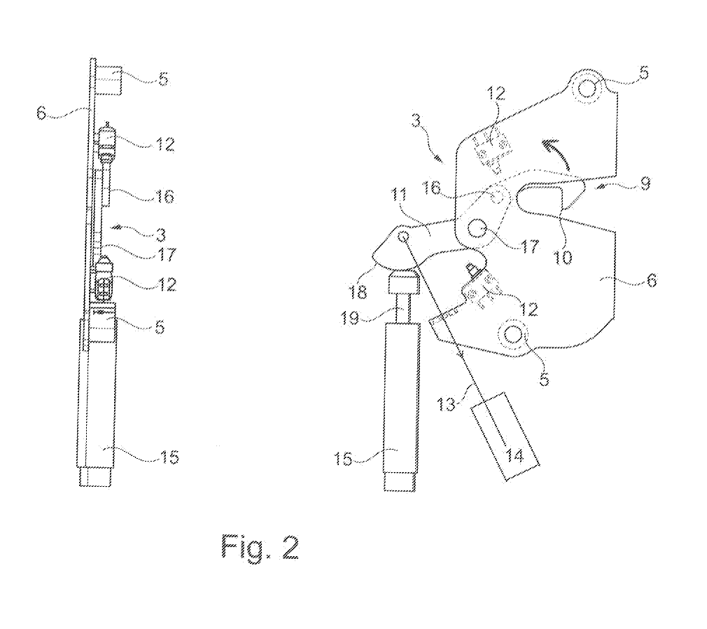

In a comparison of FIGS. 1 and 2 it becomes clear that the stop device 3 is formed as an autonomous constructional unit which can be retrofitted/converted. In actual fact, the stop device 3 is an attenuation module 3 arranged between the motor vehicle door latch 1 and the door panel T in accordance with the invention. The attenuation module 3 is designed as a constructional unit which can be modularly connected with the motor vehicle door latch 1 for the purpose of a construction kit system. In the execution example, the attenuation module 3 on the one hand and the motor vehicle door latch 1 on the other hand are screwed together as respective modules or constructional units together with the door panel T of the motor vehicle door.

In the execution example, the design is such that the attenuation module 3 is arranged between the motor vehicle door latch 1 and the motor vehicle door or its door panel T. This is expressed in particular on the basis of the left profile view in FIG. 1. A comparison with the pertaining front view in the right section of FIG. 1 makes clear that the motor vehicle door latch 1 has an L-shaped cross section which is naturally only an example and is not restrictive.

In detail, the attenuation module 3 is screwed between the motor vehicle door or the door panel T in question or the connecting panel and a latch case 4 as a component of the motor vehicle door latch 1. The aforementioned screws 2 ensure screw attachment. In actual fact, the screws 2 pass through not only the relevant openings in the motor vehicle door or the door panel T belonging to the motor vehicle door depicted in profile in the left of FIG. 1, but also spacer sleeves 5, which are connected to an adapter plate 6 as a component of the attenuation module 3. For this purpose, the latch case 4 is equipped with relevant threads or thread holes in the example case in which the screws 2 engage.

In the left part of FIG. 1 a locking bolt 7 is perceptible. In the execution example, the locking bolt 7 is connected to a motor vehicle chassis not depicted in greater detail. The locking bolt 7 may be a bracket locking bolt 7. The fixed location connection 5 to the motor vehicle chassis not depicted can be in the area of a doorpost or a B pillar in the example case.

As soon as the motor vehicle door is closed, the locking bolt 7 enters the infeed section 8 of the motor vehicle door latch 1. An infeed section 9 of the attenuation module 8 corresponds to the infeed section 8 of the motor vehicle door latch 1 or its latch case 4. This infeed module 9 is formed in the adapter plate 6.

On the basis of a comparative view of FIGS. 1 and 2 it is recognized that the overall design of the adapter plate 6 is such that with regard to its shape and size it corresponds to the shape and size of the latch case 4 of the motor vehicle door latch 1. Thus, the motor vehicle door latch 1 is mechanically supported and stiffened in the state fitted to the door panel T with the aid of the adapter plate 6. Furthermore, this design ensures that the stop device or the attenuation module 3 experiences a protected arrangement mechanically so to speak behind the adapter plate 8. The infeed section 8 in the latch case 4 or as a component of the motor vehicle door latch 1 on the one hand and the infeed section 9 of the adapter plate 6 on the other hand are adapted to one another with regard to size and contour in order that the locking bolt 7 can pass both infeed sections 8, 9 together and easily when the motor vehicle door is closed.

In this process, the locking bolt 7 interacts with a catch D which is only depicted in the left section of FIG. 1. When the motor vehicle door is closed, the locking bolt 7 transfers the catch D and also the pertaining locking mechanism initially into a pre-latching position and then into the main latching position. The transition from the pre-latching position to the main latching position can also occur in a motorized manner, as described as a possible option hereafter.

The stop device 3 comprises different components 10, 11, 12 of the attenuation module 3 on the one hand and the attenuation element 15 on the other hand. The aforementioned components 10, 11, 12 are all—apart from the stated attenuation element 15—connected to the adapter plate 6 or incorporated by the adapter plate 6. The components 10, 11, 12 in question are a deflection element 10 on the one hand and a transfer lever 11 on the other hand. Furthermore, the components 10, 11, 12 include at least one sensor 12. Within the scope of the execution example, two are executed as sensors 12 executed as a microswitch 12. Reference is made to FIG. 2 in this regard.

The deflection lever 10 is located on the transfer lever 11 wtihin the scope of the execution example. The transfer lever 11 has a bearing on an axis 17. This axis 17 is defined in the execution example by a bolt 17 arranged on the adapter plate 6 or connected thereto 17, which pivotably incorporates the transfer lever 11. Also the axis or rotational axis 16 for pivotable linkage of the deflection lever 10 on the transfer lever 11 is defined by a pertaining bolt 16.

As soon as the locking bolt 7 enters the infeed section 8 of the latch case 4 or the corresponding infeed section 9 of the adapter plate 6 during closure of the motor vehicle door, it meets the deflection lever 10. As a consequence thereof, the deflection lever 10 is pivoted upwards around its axis 16 in an anticlockwise direction, as shown by a relevant arrow in the right illustration of FIG. 2. In this process, the deflection lever 10 carries the transfer lever 11. As the deflection lever 10 is connected to the front end of the transfer lever 11, a rearward end of the transfer lever 11 or its attenuation end can interact with the attenuation element 15 arranged there.

For this purpose, the transfer lever 11 has an installation contour 18 at the attenuation end in question which works on a stamp 19. In actual fact, the closure process of the motor vehicle door described and the entry of the locking bolt 7 into the corresponding infeed sections 8, 9 corresponds to the deflection lever 10 being initially pivoted around its axis 16 in an anticlockwise direction and consequently carrying the transfer lever 11 which also accomplishes a movement in an anticlockwise direction around its axis 17 as shown in the right illustration in FIG. 2.

Thus, the installation contour 18 at the head end of the stamp 19 of the attenuation element 1.5 shifts and pushes the stamp 19 with increasing travel of the locking bolt 7 further and further into the attenuation element 15. Thus, the attenuation element 15 for example unfolds increasing attenuation forces and the locking bolt 7 is increasingly braked or attenuated.

The attenuation element 15 can involve a hydraulic attenuator filled with oil, fluid, air, etc. In principle, an elastomer attenuator is also conceivable in which the stamp 19 plunges into a relevantly started rubber mass. In addition, the invention also encompasses attenuation elements 15 which work with springs, spiral springs, for example. An aspect that all attenuation elements 15 have in common is that they brake the movement of the locking bolt 7 along the infeed section 8, 9 and thus ensure the desired movement and noise attenuation during the closure process of the motor vehicle door.

In FIG. 2, a connector 13 is then recognized, which connects the transfer lever 11 to a drive 14. In the present case, the deflection lever 10 is not restrictively designed as a closure catch 10. This means that the deflection lever or the closure catch 10 has a dual function. Initially, in conjunction with the transfer lever 11 and the attenuation element 15 it ensures that the locking bolt 7 is braked when entering the pertaining infeed section 8, 9 and experiences the already described movement and consequently also the noise attenuation. As soon as the locking bolt 7 has passed the deflection lever or the closure catch 10 in the example case and the deflection lever or the closure catch 10 has passed the upper sensor 12 in the entry process. The drive 14 is started as a result of its pivoting movement around the axis 16 in an anticlockwise direction. Because the pressurization of the sensor 12 produces a start signal for the closure process.

In the process, the closure catch or the deflection lever 10 initially reaches behind the locking bolt 7 entering the corresponding infeed section 8, 9. Now, the drive 14 starts to act and ensures via the connector 13 executed as a Bowden cable 13 that the locking bolt 7 is pulled further into the relevant infeed section 8, 9. To this end, the drive 14 exercises a pulling force referred to by an arrow in FIG. 2 on the transfer lever 11 which corresponds to the transfer lever 11 being pivoted around its axis 17 in an anticlockwise direction and moving the deflection lever or the closure catch 10 to the left in the execution example of the right illustration according to FIG. 2.

This closure process is continued until the transfer lever 11 pressurizes the lower sensor 12. Then the main latching position of the locking mechanism inside the motor vehicle door latch 1 is regularly reached. As a consequence thereof, the drive 14 is stopped and the motor vehicle door is completely closed in relation to the motor vehicle chassis. The drive 14 must also overcome any attenuation forces 15 which may have built up in principle during the described process.

However, it is also possible that the triggering of the upper sensor 12 for the start of the closure process simultaneously ensures that the attenuation element 15 is more or less switched ineffectively. For example, this can occur with the aid of a valve, drained via the fluid found inside the attenuation element 15 or transferred into a reservoir.

1. Motor vehicle door with a motor vehicle door latch and pertaining locking bolt, and with a stop device with a corresponding attenuation element, whereby the stop device at least for the locking bolt entering the motor vehicle door latch with the relevant locking bolt interacts with the movement attenuation, characterized in that the stop device is formed as an attenuation module arranged between the motor vehicle door latch and a door panel.

2. Motor vehicle door in accordance with claim 1, characterized in that the attenuation module demonstrates at least one deflection lever preferably arranged in the vicinity of an infeed section of the motor vehicle door latch and interacting with the locking bolt.

3. Motor vehicle door in accordance with claim 1, characterized in that the attenuation module is equipped with an adapter plate incorporating individual components.

4. Motor vehicle door in accordance with claim 3, characterized in that the adapter plate is connected to the motor vehicle door latch by means of spacer sleeves.

5. Motor vehicle door in accordance with claim 3, characterized in that the components incorporated by the adapter plate are all connected to the adapter plate on one side.

6. Motor vehicle door in accordance with claim 4, characterized in that the components are located in an intermediate space defined by the spacer sleeves.

7. Motor vehicle door in accordance with claim 3, characterized in that the attenuation module demonstrates a transfer lever in addition to the deflection lever.

8. Motor vehicle door in accordance with claim 7, characterized in that both levers are mechanically connected via shifting contours.

9. Motor vehicle door in accordance with claim 8, characterized in that the deflection lever is pivotably located on the transfer lever.

10. Motor vehicle door in accordance with claim 9, characterized in that the transfer lever is pivotably connected to the adapter plate.

11. Motor vehicle door in accordance with claim 7, characterized in that the deflection lever is pivotably located on the transfer lever.

12. Motor vehicle door in accordance with claim 7, characterized in that the transfer lever (11) is pivotably connected to the adapter plate (6).

13. Motor vehicle door in accordance with claim 1, characterized in that the attenuation module is equipped with an adapter plate incorporating individual components.

14. Motor vehicle door in accordance with claim 13, characterized in that the components incorporated by the adapter plate are all connected to the adapter plate on one side.

15. Motor vehicle door in accordance with claim 13, characterized in that the attenuation module demonstrates a transfer lever in addition to the deflection lever.

16. Motor vehicle door in accordance with claim 15, characterized in that both levers are mechanically connected via shifting contours.

17. Motor vehicle door in accordance with claim 15, characterized in that the deflection lever is pivotably located on the transfer lever.

18. Motor vehicle door in accordance with claim 15, characterized in that the transfer lever is pivotably connected to the adapter plate.
